(19) United States
(12) Patent Application Publication
(10) Pub. No.: US 2025/0158108 A1
(43) Pub. Date: May 15, 2025

(54) MAGNESIUM SECONDARY BATTERY AND METHOD FOR MANUFACTURING MAGNESIUM SECONDARY BATTERY

(71) Applicant: THE FURUKAWA BATTERY CO., Ltd., Yokohama-shi (JP)

(72) Inventor: Naoki TAKEGUCHI, Fukushima (JP)

(73) Assignee: THE FURUKAWA BATTERY CO., Ltd., Yokohama-shi (JP)

(21) Appl. No.: 18/928,288

(22) Filed: Oct. 28, 2024

(30) Foreign Application Priority Data
Nov. 13, 2023 (JP) 2023-192793

(51) Int. Cl. H01M 10/054; H01M 4/46; H01M 10/44

(52) U.S. Cl. CPC H01M 10/054; H01M 4/466; H01M 10/44

(57) ABSTRACT

A magnesium secondary battery includes: a positive electrode; a negative electrode having a magnesium layer made of a magnesium metal material; a separator; and an electrolytic solution, in which in powder X-ray diffraction measurement of the negative electrode using a CuKα ray, a peak intensity ratio represented by (002)/(110) obtained from a diffraction peak representing a (002) plane within a range of 2θ=35°±5° and a diffraction peak representing a (110) plane within a range of 2θ=57°±5° is 7 or more and 12 or less, and the separator has a porosity W (%) of 40≤W≤50 and a film thickness X (μm) of 20≤X≤40.

### CROSS-REFERENCE TO RELATED APPLICATION(S)

This application claims the benefit of priority from Japanese Patent Application No. 2023-192793 filed on Nov. 13, 2023, the entire contents of which are incorporated herein by reference.

### BACKGROUND

### 1. Technical Field

The present disclosure relates to a magnesium secondary battery and a method for manufacturing the magnesium secondary battery.

### 2. Related Art

In recent years, environmental problems have become serious problems. Therefore, natural energy power generation is desired from a viewpoint of environmental load. However, supply of natural energy is unstable, and electric energy generated once needs to be stored. Therefore, it is required to increase a capacity of a power storage device such that such large electric energy can be stored.

Currently, a lithium ion secondary battery and a magnesium secondary battery are known as power storage devices. Among these batteries, the magnesium secondary battery is attracting attention as a battery in which a high energy density is expected because a carrier is a divalent magnesium ion (See, for example, WO 2020/013328 A). In addition, magnesium metal is stable in air and has a theoretical capacity per volume of about 1.5 times as compared with lithium metal, and thus is required to be put into practical application as a metal secondary battery using magnesium metal for a negative electrode.

### SUMMARY

However, there are many difficulties in practical application of the magnesium secondary battery, and large overvoltage is also one of hurdles to practical application.

The disclosure has been made in view of the above problems, and it is desirable to provide a magnesium secondary battery in which overvoltage is reduced, and a method for manufacturing the magnesium secondary battery.

In some embodiments, a magnesium secondary battery includes: a positive electrode; a negative electrode having a magnesium layer made of a magnesium metal material; a separator; and an electrolytic solution, in which in powder X-ray diffraction measurement of the negative electrode using a CuKα ray, a peak intensity ratio represented by (002)/(110) obtained from a diffraction peak representing a (002) plane within a range of 2θ=35°±5° and a diffraction peak representing a (110) plane within a range of 2θ=57°±5° is 7 or more and 12 or less, and the separator has a porosity W (%) of 40≤W≤50 and a film thickness X (μm) of 20≤X≤40. Note that a diffraction peak intensity ratio may be simply referred to as “peak intensity ratio”.

When the magnesium secondary battery is used, it is possible to provide a magnesium secondary battery capable of reducing overvoltage.

In some embodiments, provided is a method for manufacturing a magnesium secondary battery including a positive electrode, a negative electrode having a magnesium layer made of a magnesium alloy, a separator, and an electrolytic solution. The method includes an activation step of performing charging and discharging at 5 mA/cm² or more.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is an exploded perspective view for explaining a structure of a magnesium secondary battery according to an embodiment of the disclosure.

### DETAILED DESCRIPTION

Hereinafter, a first embodiment of the disclosure will be described, but the disclosure is not limited to the following description. In addition, various changes or improvements can be added to the present embodiment, and a mode to which such changes or improvements are added can also be included in the disclosure.

A magnesium secondary battery in the disclosure includes a positive electrode, a separator, a negative electrode, an electrolytic solution, and an exterior body that houses the positive electrode, the separator, the negative electrode, and the electrolytic solution. The positive electrode and the negative electrode are disposed such that active materials thereof face each other, and the separator is present between the positive electrode and the negative electrode.

### Embodiment

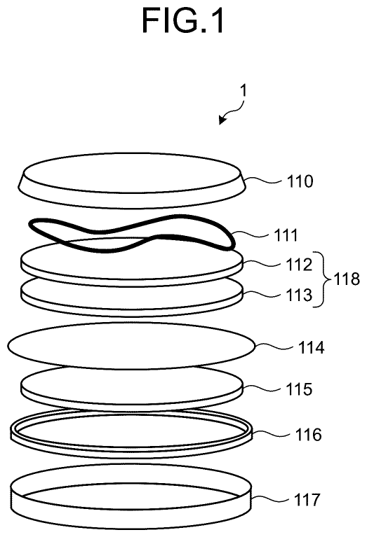

FIG. 1 is an exploded perspective view for explaining a structure of a magnesium secondary battery according to an embodiment of the disclosure. A magnesium secondary battery 1 includes a case 110, a leaf spring 111, a positive electrode current collector 112, a positive electrode mixture layer 113, a separator 114, a negative electrode 115, a gasket 116, and a cap 117. Note that the positive electrode current collector 112 and the positive electrode mixture layer 113 constitute a positive electrode 118. The disclosure is not limited to this mode, and a mode including a plurality of positive electrodes and a plurality of negative electrodes is also preferably used, and can also be used as a magnesium secondary battery formed by laminate pouch.

In the magnesium secondary battery 1, the case 110 and the cap 117 are fixed by crimping or the like, and an inside of the magnesium secondary battery 1 is filled with a nonaqueous electrolytic solution. The magnesium secondary battery 1 is liquid-tightly sealed by the case 110, the gasket 116, and the cap 117. The positive electrode current collector 112, the positive electrode mixture layer 113, the separator 114, and the negative electrode 115 are biased toward the cap 117 by the leaf spring 111. As a result, a state in which the members are in close contact with each other is maintained.

### Positive Electrode

An embodiment of the disclosure provides a positive electrode for a magnesium secondary battery (positive electrode 118) including at least a positive electrode current collector and a positive electrode mixture layer disposed on one side or both sides of the positive electrode current collector.

A material constituting the positive electrode current collector 112 is not particularly limited, but a metal is preferably used. Specific examples thereof include copper, aluminum, nickel, stainless steel, titanium, and an alloy. Among these metals, aluminum is preferable from a viewpoint of electron conductivity and battery operating potential.

A binder used for the positive electrode mixture layer 113 is, for example, one of polyethylene, polypropylene, an ethylene propylene terpolymer, a butadiene rubber, a styrene butadiene rubber, a butyl rubber, polytetrafluoroethylene, poly(meth)acrylate, polyvinylidene fluoride, polyethylene oxide, polypropylene oxide, polyepichlorohydrin, polyfachazene, and polyacrylonitrile, or a mixture thereof.

Examples of a positive electrode active material include MgCo₂O₄, MgFeSiO₄, S, MnO₂, Mo₆S₈, and V₂O₅. In order to improve electron conductivity, for example, one of conductive carbon powders such as graphite and carbon black, a carbon nanotube, a carbon nanofiber, and graphene, or a mixture thereof may be contained. A substance containing a magnesium element is, for example, MgCo₂O₄ or MgFeSiO₄, and a substance containing no magnesium element is, for example, MnO₂, Mo₆S₈, or V₂O₅. As described later, the substance containing a magnesium element is usually a main component of a positive electrode of a battery that starts with charging.

### Negative Electrode

An embodiment of the disclosure provides a negative electrode for a magnesium secondary battery (negative electrode 115) including at least a negative electrode current collector and a magnesium layer made of a magnesium metal material, disposed on one side or both sides of the negative electrode current collector. The negative electrode current collector does not have to be used.

A material constituting the negative electrode current collector is not particularly limited, but a metal is preferably used. Specific examples thereof include copper, aluminum, nickel, stainless steel, titanium, and an alloy. Among these metals, copper is preferable from a viewpoint of electron conductivity and battery operating potential.

The magnesium metal material is a magnesium metal alloy or pure magnesium. In particular, a magnesium alloy containing 3% by weight or more of other metals is preferable. This is because the magnesium alloy is affected by a method for controlling an electrode surface state described later more strongly than pure magnesium. Furthermore, a crystal structure is preferably a hexagonal close-packed (hcp) structure. More preferably, the magnesium metal material is a magnesium metal alloy containing aluminum and zinc. The magnesium metal material may contain copper. A reason why it is preferable to use a magnesium metal alloy negative electrode containing aluminum and zinc is that the magnesium metal alloy negative electrode is stable in the atmosphere and excellent in handleability.

In the magnesium metal material, a peak intensity ratio Y represented by (002)/(110) obtained from a diffraction peak representing a (002) plane within a range of 2θ=35°±5° and a diffraction peak representing a (110) plane within a range of 2θ=57°±5° is 7 or more and 12 or less. When a negative electrode other than the negative electrode of the disclosure is used, it is difficult to insert and extract magnesium ions into and from a bulk, and favorable charging and discharging characteristics cannot be necessarily obtained.

In the present embodiment, in powder X-ray diffraction measurement, the magnesium metal material is characterized in that a peak intensity ratio Y represented by (002)/(110) obtained from a diffraction peak representing a (002) plane within a range of 2θ=35°±5° and a diffraction peak representing a (110) plane within a range of 2θ=57°±5° is 7 or more and 12 or less (7≤Y≤12). A reason why it is preferable to use the negative electrode according to the present embodiment is to make suppression of overvoltage possible. This is a problem caused by a fact that the magnitude of overvoltage varies depending on which surface electrochemical activity depends on in an electrode surface in a magnesium alloy or pure magnesium. In order to solve this problem, a magnesium metal alloy negative electrode having a peak intensity ratio Y of (002)/(110) plane of 12≥Y in X-ray diffraction measurement is used. (001) and (002) plane orientations in which an orientation plane of magnesium is a bottom surface portion are electrochemically inactive planes. On the other hand, (101) and (110) plane orientations derived from a side surface portion are electrochemically active planes. Note that it is known that the (110) plane is more electrochemically active than the (001) plane (See, for example, C. Ling et al., electrochmica Acta 76 (2θ12), 270-274). Together with the (001) plane, the (002) plane indicating orientation of a bottom surface portion of magnesium is also more inactive than (110).

Therefore, when a magnesium metal alloy negative electrode in which the peak intensity ratio Y of the (002)/(110) plane is 12≥Y is used, many active surfaces are present on an electrode surface.

Note that, when a magnesium metal alloy negative electrode in which the peak intensity ratio Y is Y<7 is used, overvoltage increases during an activation step, and activation cannot be performed in some cases.

By using a magnesium metal alloy having a surface state in which the peak intensity ratio Y of the (002)/(110) plane is 12≥Y, many active surfaces are present on an electrode surface, and thus magnesium ions are more smoothly moved. As a result, it is possible to reduce overvoltage at the time of dissolution and precipitation of magnesium.

Usual magnesium metal negative electrodes including a magnesium metal alloy negative electrode that has just been completed as an alloy and a pure magnesium negative electrode do not satisfy a condition that the peak intensity ratio Y of the (002)/(110) plane is 7 or more and 12 or less. Therefore, in order to control an electrode surface state as in the above magnesium metal alloy negative electrode, an activation step was performed on a magnesium metal alloy negative electrode or a pure magnesium negative electrode. At this time, when constant current charging and discharging is performed at a low current density, for example, less than 5 mA/cm², magnesium to be electrodeposited is a particle having many bottom surface portions ((002) plane) which are thermodynamically stable crystal planes. On the other hand, by performing constant current charging and discharging at a high current density, a particle having many thermodynamically unstable side surface portions ((110) plane) is electrodeposited. That is, by performing a manufacturing method including an activation step in which a current density is controlled, it is possible to prepare a magnesium metal alloy negative electrode in which the peak intensity ratio Y of the (002)/(110) plane is 12≥Y.

The peak intensity ratio Y of the (002)/(110) plane can be adjusted by, for example, a current density during the activation step. At this time, when the current density is 5 mA/cm² or more (hereinafter, also referred to as a high current density), large orientation occurs on a surface of electrodeposited magnesium in the electrochemically active side surface portion ((110) plane or (100) plane), and the intensity ratio Y also increases. Note that, when the current density is excessively increased, overvoltage increases, and constant current charging and discharging is impossible. Therefore, the current density is preferably 5 mA/cm² or more and 25 mA/cm² or less, and more preferably 5 mA/cm² or more and 15 mA/cm² or less.

Here, in the negative electrode of the disclosure, even when the magnesium alloy or the pure magnesium as the negative electrode is not dissolved at the time of initial discharging, it is possible to suppress overvoltage and internal short circuit. This is because generation of a passivation film (oxide film) on a surface of the negative electrode is prevented. This is also suitable for a battery of a type that requires charging immediately after assembling cells, such as a battery containing a magnesium element in a positive electrode (in the present specification, also referred to as “battery that starts with charging”). Whether or not a battery starts with charging can be confirmed by whether the battery starts with insertion of magnesium ions into a positive electrode or starts with extraction of magnesium ions from the positive electrode from, for example, internal components obtained by scraping surfaces of the positive electrode and the negative electrode even after the activation step, and a person skilled in the art can easily determine whether or not the battery starts with charging.

Note that the magnesium alloy excluding a special alloy has an hcp structure as a crystal structure.

Electrolytic solution A magnesium salt contained in the nonaqueous electrolytic solution is, for example, one selected from MgCl₂, MgBH₄, Mg(NO₃)₂, Mg (TFSI)₂, Mg(SO₂CF₃)₂, Mg(BF₄)₂, Mg(CF₃SO₃)₂, and Mg(PF₆)₂, or a mixture of two or more types thereof, but are not necessarily limited thereto.

A nonaqueous solvent contained in the nonaqueous electrolytic solution is not particularly limited, and is, for example, one selected from dimethyl carbonate (DMC), diethyl carbonate (DEC), dipropyl carbonate (DPC), ethyl methyl carbonate (EMC), ethylene carbonate (EC), propylene carbonate (PC), methyl propionate, methyl acetate, methyl formate, methyl butyrate, dioxolane, 2-methyltetrahydrofuran, tetrahydrofuran, dimethoxyethane, γ-butyrolactone, acetonitrile, benzonitrile, diethylene glycol dimethyl ether (diglyme), triethylene glycol dimethyl ether (triglyme), tetraglyme dimethyl ether (tetraglyme), and sulfolane, or a mixture of two or more types thereof.

### Separator

Examples of the separator include a porous sheet separator made of a polymer or a fiber, and a nonwoven fabric separator. The separator has a porosity W (%) of 40≤W≤50 and a film thickness X (μm) of 20≤X≤40. Since the electrode surface is an active surface, a sufficient effect can be obtained even when a separator having a porosity of more than 50%, which is preferably used in a magnesium secondary battery, is not used. In addition, when the film thickness is also within the above range, since the electrode surface is an active surface, magnesium to be electrodeposited is a small particle and precipitated in a multifaceted manner, and short circuit does not occur.

Use of the separator within the above range makes it possible to suppress generation of a passivation film on a negative electrode surface by the peak intensity ratio of the disclosure, and to suppress coarsening of magnesium to be electrodeposited, and thus an effect of suppressing overvoltage and suppressing internal short circuit can be expected. Due to these effects, the separator within the above range is more suitable also for a battery that starts with charging.

In the present embodiment, in the magnesium secondary battery 1, the leaf spring 111, the positive electrode current collector 112, the positive electrode mixture layer 113, the separator 114, the negative electrode 115, and the gasket 116 are arranged in this order, then these are sandwiched between the case 110 and the cap 117, a nonaqueous electrolytic solution is filled thereinto, the case 110 and the cap 117 are fixed by crimping or the like to liquid-tightly seal the magnesium secondary battery 1, and then the activation step is performed. In this activation step, it is preferable to perform ten cycles or more, in which one cycle includes performing charging for one hour or more at a current density of 5 mA/cm² or more and performing discharging for one hour or more at a current density of 5 mA/cm² or more. In addition, as an upper limit of voltage at the time of charging, it is desirable to perform the activation step while keeping a state of charge (SOC), which is a state of charging of the battery, at 10% or more and 50% or less. A maximum charging state may be 10% or more and 50% or less in one cycle, but the maximum charging state is more preferably 10% or more and 50% or less in all cycles. As a result, it is possible to reliably obtain a negative electrode having the above-described peak intensity ratio Y≤12.

### EXAMPLES

Hereinafter, the disclosure will be described in more detail by exemplifying Examples, but the disclosure is not limited to the following modes at all.

### Level 1

### Constant Current Test

In Level 1, a constant current test was performed on a symmetric cell using a magnesium alloy containing 3% by weight of aluminum and 1% by weight of zinc as an electrode, using a polyethylene separator having a porosity of 47% and a thickness of 25 μm as a separator, using an electrolytic solution obtained by adding LiBH₄ as an additive to Mg(TSFA)₂/G2 (diethyleneglycol dimethyl ether) as an electrolytic solution, and using a laminated exterior body as an exterior body. As measurement conditions, 100 cycles were performed, in which one cycle includes performing charging for one hour at 1 mA/cm² and performing discharging for one hour at 1 mA/cm², and a measurement temperature was room temperature (25° C.).

### Activation Step

Using the above cell, before the constant current test was performed, as an activation step, an activation step of performing ten cycles was performed, in which one cycle includes performing charging for one hour at 5 mA/cm² and performing discharging for one hour at 5 mA/cm².

Test results in Level 1 are presented in Table 1.

TABLE 1

| | Activation | | | |
|---|---|---|---|---|
| | current | | | Peak intensity |
| | value | Activation | | ratio of |
| | (mA/cm²) | time (h) | SOC (%) | (002)/(110) |
| Level 1 | 5 | 1 | 22.7 | 9.99 |
| Level 2 | 10 | 1 | 45.5 | 7.62 |
| Level 3 | 5 | 0.5 | 11.4 | 11.04 |
| Level 4 | 4 | 1 | 13.62 | 12.18 |
| Level 5 | 1 | 1 | 4.54 | 16.8 |
| Level 6 | 5 | 0.4 | 9.12 | 13.33 |
| Level 7 | 5 | 2.5 | 56.75 | 6.1 |
| Level 8 | 25 | 1 | More than | Charging is |
| | | | 100 | impossible |
| Level 9 | None | None | None | 19.4 |
| Level 10 | 5 | 1 | 22.7 | 9.99 |
| Level 11 | 5 | 1 | 22.7 | 9.99 |
| Level 12 | 5 | 1 | 22.7 | 9.99 |
| Level 13 | 5 | 1 | 22.7 | 9.99 |
| Level 14 | 5 | 1 | 22.7 | 9.99 |
| Level 15 | 5 | 1 | 22.7 | 9.99 |
| Level 16 | 5 | 1 | 22.7 | 9.99 |
| Level 17 | 5 | 1 | 22.7 | 9.99 |
| Level 18 | 5 | 1 | 22.7 | 9.99 |
| Level 19 | 5 | 1 | 22.7 | 9.99 |

| | | | Overvoltage | Presence or |
|---|---|---|---|---|
| | Separator | Separator | after 100 | absence of internal |
| | porosity | thickness | cycles | short circuit after |
| | (%) | (μm) | (V) | 100 cycles |
| Level 1 | 47 | 25 | 0.196 | Absence |
| Level 2 | 47 | 25 | 0.052 | Absence |
| Level 3 | 47 | 25 | 0.22 | Absence |
| Level 4 | 47 | 25 | 0.427 | Absence |
| Level 5 | 47 | 25 | 0.39 | Absence |
| Level 6 | 47 | 25 | 0.31 | Absence |
| Level 7 | 47 | 25 | — | Presence |
| Level 8 | 47 | 25 | — | — |
| Level 9 | 47 | 25 | 0.59 | Absence |
| Level 10 | 30 | 30 | 0.44 | Absence |
| Level 11 | 70 | 40 | — | Presence |
| Level 12 | 47 | 10 | — | Presence |
| Level 13 | 47 | 50 | 0.46 | Absence |
| Level 14 | 47 | 20 | 0.153 | Absence |
| Level 15 | 47 | 40 | 0.27 | Absence |
| Level 16 | 40 | 25 | 0.21 | Absence |
| Level 17 | 50 | 25 | 0.177 | Absence |
| Level 18 | 30 | 10 | — | Presence |
| Level 19 | 70 | 50 | — | Presence |

### Level 2

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for one hour at 10 mA/cm² and performing discharging for one hour at 10 mA/cm². Test results in Level 2 are presented in Table 1.

### Level 3

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for 0.5 hours at 5 mA/cm² and performing discharging for 0.5 hours at 5 mA/cm². Test results in Level 3 are presented in Table 1.

### Level 4

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for one hour at 4 mA/cm² and performing discharging for one hour at 4 mA/cm². Test results in Level 4 are presented in Table 1.

### Level 5

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for one hour at 1 mA/cm² and performing discharging for one hour at 1 mA/cm². Test results in Level 5 are presented in Table 1.

### Level 6

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for 0.4 hours at 5 mA/cm² and performing discharging for 0.4 hours at 5 mA/cm². Test results in Level 6 are presented in Table 1.

### Level 7

A structure of a battery is similar to that of Level 1. As a test method, a test was performed under similar conditions to Level 1 except for the activation step. In addition, before the constant current test was performed, as an activation step, an activation step of performing ten cycles was performed, in which one cycle includes performing charging for 2.5 hours at 5 mA/cm² and performing discharging for 2.5 hours at 5 mA/cm². Test results in Level 7 are presented in Table 1.

### Level 8

A structure of a battery is similar to that of Level 1. As a test method, a test was performed under similar conditions to Level 1 except for the activation step. In addition, before the constant current test was performed, as an activation step, an activation step of performing ten cycles was attempted to be performed, in which one cycle includes performing charging for one hour at 25 mA/cm² and performing discharging for one hour at 25 mA/cm². However, the SOC exceeded 100%, and therefore the experiment was interrupted halfway. Test results in Level 8 are presented in Table 1.

### Level 9

A structure of a battery is similar to that of Level 1. As a test method, a test was performed under similar conditions to Level 1 except for the activation step. In addition, the activation step was not performed. Test results in Level 9 are presented in Table 1.

### Level 10

A structure of a battery is similar to that of Level 1 except for a separator. As the separator, a polyethylene separator having a porosity of 30% and a thickness of 30 μm was used. As a test method, a test was performed under similar conditions to Level 1 including the activation step. Test results in Level 10 are presented in Table 1.

### Level 11

A structure of a battery is similar to that of Level 1 except for a separator. As the separator, a polyethylene separator having a porosity of 70% and a thickness of 40 μm was used. As a test method, a test was performed under similar conditions to Level 1 including the activation step. Test results in Level 11 are presented in Table 1.

### Level 12

A structure of a battery is similar to that of Level 1 except for a separator. As the separator, a polyethylene separator having a porosity of 47% and a thickness of 10 μm was used. As a test method, a test was performed under similar conditions to Level 1 including the activation step. Test results in Level 12 are presented in Table 1.

### Level 13

A structure of a battery is similar to that of Level 1 except for a separator. As the separator, a polyethylene separator having a porosity of 47% and a thickness of 50 μm was used. As a test method, a test was performed under similar conditions to Level 1 including the activation step. Test results in Level 13 are presented in Table 1.

### Level 14

A structure of a battery is similar to that of Level 1 except for a separator. As the separator, a polyethylene separator having a porosity of 47% and a thickness of 20 μm was used. As a test method, a test was performed under similar conditions to Level 1 including the activation step. Test results in Level 14 are presented in Table 1.

### Level 15

A structure of a battery is similar to that of Level 1 except for a separator. As the separator, a polyethylene separator having a porosity of 47% and a thickness of 40 μm was used. As a test method, a test was performed under similar conditions to Level 1 including the activation step. Test results in Level 15 are presented in Table 1.

### Level 16

A structure of a battery is similar to that of Level 1 except for a separator. As the separator, a polyethylene separator having a porosity of 40% and a thickness of 25 μm was used. As a test method, a test was performed under similar conditions to Level 1 including the activation step. Test results in Level 16 are presented in Table 1.

### Level 17

A structure of a battery is similar to that of Level 1 except for a separator. As the separator, a polyethylene separator having a porosity of 50% and a thickness of 25 μm was used. As a test method, a test was performed under similar conditions to Level 1 including the activation step. Test results in Level 17 are presented in Table 1.

### Level 18

A structure of a battery is similar to that of Level 1 except for a separator. As the separator, a polyethylene separator having a porosity of 30% and a thickness of 10 μm was used. As a test method, a test was performed under similar conditions to Level 1 including the activation step. Test results in Level 18 are presented in Table 1.

### Level 19

A structure of a battery is similar to that of Level 1 except for a separator. As the separator, a polyethylene separator having a porosity of 70% and a thickness of 50 μm was used. As a test method, a test was performed under similar conditions to Level 1 including the activation step. Test results in Level 19 are presented in Table 1.

From Table 1, in Levels 1 to 3 where the (002)/(110) peak intensity ratio Y was 7 or more and 12 or less, overvoltage after 100 cycles was 0.22 V or less, which was favorable, and favorable values were obtained without occurrence of internal short circuit. In Levels 1 to 3 and 6 including the activation step of performing charging at 5 mA/cm² or more, overvoltage after one cycle was 0.31 V or less, which was favorable, and favorable values were obtained without occurrence of internal short circuit. On the other hand, in Levels 4 and 5 where the (002)/(110) peak intensity ratio Y was more than 12 and in Level 9 where the activation step was not performed, overvoltage after 100 cycles was 0.427 V or more, which was not preferable. In Level 7 where Y was less than 7, internal short circuit occurred, and in Level 8 where an activation current value was high, the activation step itself was impossible. From a viewpoint of the separator, in Levels 11 and 12 where a porosity was more than 50% or a thickness was less than 20 μm, internal short circuit occurred, and in Levels 10 and 13 where a porosity was less than 40% or a thickness was more than 40 μm, overvoltage after 100 cycles was 0.44 V or more, which was not preferable. In Levels 18 and 19 where both a porosity and a thickness were not appropriate, internal short circuit occurred, which was not preferable. On the other hand, in Levels 14 to 17 where a porosity was 40% or more and 50% or less and a thickness was 20 or more and 40 μm or less, overvoltage after 100 cycles was 0.27 or less, which was preferable.

From the above results, it is possible to provide a magnesium secondary battery capable of reducing overvoltage by controlling an electrochemically active electrode surface state in a negative electrode.

According to the disclosure, in the magnesium secondary battery, occurrence of internal short circuit can be suppressed while overvoltage is reduced.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnesium secondary battery comprising:
a positive electrode;
a negative electrode having a magnesium layer made of a magnesium alloy or pure magnesium;
a separator; and
an electrolytic solution, wherein
in powder X-ray diffraction measurement of the negative electrode using a CuKα ray, a peak intensity ratio represented by (002)/(110) obtained from a diffraction peak representing a (002) plane within a range of 2θ=35°±5° and a diffraction peak representing a (110) plane within a range of 2θ=57°±5° is 7 or more and 12 or less, and the separator has a porosity W (%) of 40≤W≤50 and a film thickness X (μm) of 20≤X≤40.

2. The magnesium secondary battery according to claim 1, wherein
the magnesium alloy contains aluminum and zinc.

3. The magnesium secondary battery according to claim 1, wherein
the magnesium secondary battery is a battery that starts with charging.

4. A method for manufacturing a magnesium secondary battery including a positive electrode, a negative electrode having a magnesium layer made of a magnesium alloy, a separator, and an electrolytic solution, the method comprising
an activation step of performing charging and discharging at 5 mA/cm² or more.

5. The method for manufacturing a magnesium secondary battery according to claim 4, wherein one charging and discharging cycle in which charging is performed for one hour or more and discharging is performed for one hour or more is performed for ten cycles or more.

6. The method for manufacturing a magnesium secondary battery according to claim 4, further comprising one charging and discharging cycle in which an upper limit of SOC during charging is 10% or more and 50% or less.

7. The method for manufacturing a magnesium secondary battery according to claim 4, wherein a negative electrode having a magnesium layer made of a magnesium alloy containing 3% by weight or more of other metals is used.

8. The method for manufacturing a magnesium secondary battery according to claim 4, wherein a substance containing a magnesium element is used for a positive electrode.
